(19) United States
(12) Patent Application Publication
(10) Pub. No.: US 2018/0109118 A1
(43) Pub. Date: Apr. 19, 2018

(54) CHARGING METHOD, CHARGING APPARATUS, AND TERMINAL

(71) Applicant: Huawei Technologies Co., Ltd., Shenzhen, Guangdong (CN)

(72) Inventors: Wenyong Sun, Beijing (CN); Jun Hu, Beijing (CN)

(21) Appl. No.: 15/568,426

(22) PCT Filed: May 19, 2015
(86) PCT No.: PCT/CN2015/079281

§ 371 Date: Oct. 20, 2017

(51) Int. Cl. H02J 7/00

(52) U.S. Cl. CPC H02J 7/007; H02J 7/0047; H02J 7/0042

(57) ABSTRACT

A charging method, a charging apparatus, and a terminal are disclosed. The method includes: identifying, when it is detected that a charging apparatus is inserted into a charging port of a terminal by using a charging cable, a first voltage value of the charging port; setting a second charging current; identifying a second voltage value of the charging port at the second charging current; calculating a cable impedance of the charging cable according to the first voltage value, the second charging current, and the second voltage value; and adjusting a suitable charging current of the charging apparatus according to the cable impedance of the charging cable. Therefore, the terminal can adapt to different charging apparatuses, improving charging experience of a user.

### CROSS-REFERENCE TO RELATED APPLICATIONS

This application is a national stage of International Application No. PCT/CN2015/079281, filed on May 19, 2015, which is hereby incorporated by reference in its entirety.

### TECHNICAL FIELD

Embodiments of the present invention relate to the field of information technologies, and in particular, to a charging method, a charging apparatus, and a terminal.

### BACKGROUND

With rapid development of mobile phones, there are more types of mobile phones in a market. Adapters and USB (Universal Serial Bus, Universal Serial Bus, USB for short) cables, as necessary accessories of the mobile phones, are also of a wide variety. Generally, there are multiple mobile phone chargers in each ordinary family. These chargers mostly have different power and electrical characteristics. In addition, according to a unified port standard set by Ministry of Industry and Information Technology, different mobile phones may be charged by using different USB cables. Currently, smartphones all have relatively large battery capacities, and charging currents set by the mobile phones are also relatively large, so that charging the mobile phones by using original chargers may have no problem. There are also many chargers that are non-original but conform to national standards in a family. However, when a mobile phone is charged by using a non-original adapter, overcurrent protection is generated by the adapter and charging cannot be performed, because a charging current set by the mobile phone is excessively large and exceeds a rated current of the adapter. When a user uses a USB cable of relatively poor quality, a voltage shunted to the cable is excessively large, and a voltage reaching a mobile phone end is excessively low due to an impedance problem of the USB cable. Consequently, there are problems that charging is slow, charging cannot even be performed, and the like.

### SUMMARY

The present invention provides a charging method, a charging apparatus, and a terminal, to enable a terminal to adapt to different charging apparatuses, improving charging experience of a user.

A first aspect of the present invention provides a charging method, where the method includes: identifying, when it is detected that a charging apparatus is inserted into a charging port of a terminal by using a charging cable, a first voltage value of the charging port; setting a second charging current; identifying a second voltage value of the charging port at the second charging current; calculating a cable impedance of the charging cable according to the first voltage value, the second charging current, and the second voltage value; and adjusting a suitable charging current of the charging apparatus according to the cable impedance of the charging cable.

With reference to the first aspect, in a first possible implementation manner of the first aspect, the calculating a cable impedance of the charging cable according to the first voltage value, the second charging current, and the second voltage value is specifically: R=(V₁−V₂)/I₂, where R is the cable impedance of the charging cable, V₁ is the first voltage value, V₂ is the second voltage value, and I₂ is the second charging current.

With reference to the first possible implementation manner of the first aspect, in a second possible implementation manner of the first aspect, the method further includes: prompting a user when the cable impedance of the charging cable is greater than a preset impedance value.

With reference to any one of the first aspect, the first possible implementation manner of the first aspect, or the second possible implementation manner of the first aspect, in a third possible implementation manner of the first aspect, the adjusting a suitable charging current of the charging apparatus according to the cable impedance of the charging cable includes: adjusting a third charging current to a fourth charging current; identifying a fourth voltage value of the charging port at the fourth charging current; calculating an output voltage value of the charging apparatus according to a rated voltage value of the charging apparatus, the fourth charging current and the cable impedance of the charging cable; and determining, if the fourth voltage value is less than the output voltage value of the charging apparatus, that the third charging current is the suitable charging current of the charging apparatus.

With reference to the third possible implementation manner of the first aspect, in a fourth possible implementation manner of the first aspect, the calculating an output voltage value of the charging apparatus according to a rated voltage value of the charging apparatus, the fourth charging current and the cable impedance of the charging cable is specifically: V=V_{adapter}−I₄×R, where V is the output voltage value of the charging apparatus, V_{adapter} is the rated voltage value of the charging apparatus, I₄ is the fourth charging current, and R is the cable impedance of the charging cable.

A second aspect of the present invention provides a charging apparatus, where the apparatus includes: a first identification unit, configured to identify, when it is detected that a charging apparatus is inserted into a charging port of a terminal by using a charging cable, a first voltage value of the charging port; a setting unit, configured to set a second charging current; a second identification unit, configured to identify a second voltage value of the charging port at the second charging current; a first calculation unit, configured to calculate a cable impedance of the charging cable according to the first voltage value, the second charging current, and the second voltage value; and a first adjustment unit, configured to adjust a suitable charging current of the charging apparatus according to the cable impedance of the charging cable.

With reference to the second aspect, in a first possible implementation manner of the second aspect, the first calculation unit is specifically configured to: R=(V₁−V₂)/I₂, where R is the cable impedance of the charging cable, V₁ is the first voltage value, V₂ is the second voltage value, and I₂ is the second charging current.

With reference to the first possible implementation manner of the second aspect, in a second possible implementation manner of the second aspect, the apparatus further includes a prompt unit, configured to prompt a user when the cable impedance of the charging cable is greater than a preset impedance value.

With reference to any one of the second aspect, the first possible implementation manner of the second aspect, or the second possible implementation manner of the second aspect, in a third possible implementation manner of the second aspect, the first adjustment unit includes: a second adjustment unit, configured to adjust a third charging current to a fourth charging current; a third identification unit, configured to identify a fourth voltage value of the charging port at the fourth charging current; a second calculation unit, configured to calculate an output voltage value of the charging apparatus according to a rated voltage value of the charging apparatus, the fourth charging current and the cable impedance of the charging cable; and a determining unit, configured to determine, if the fourth voltage value is less than the output voltage value of the charging apparatus, that the third charging current is the suitable charging current of the charging apparatus.

With reference to the third possible implementation manner of the second aspect, in a fourth possible implementation manner of the second aspect, the second calculation unit is specifically configured to: V=V_{adapter}−I₄×R, where V is the output voltage value of the charging apparatus, V_{adapter} is the rated voltage value of the charging apparatus, I₄ is the fourth charging current, and R is the cable impedance of the charging cable.

A third aspect of the present invention provides a terminal, where the terminal includes: one or more processors; a memory; and one or more programs, where the one or more programs are stored in the memory, and are configured to be executed by the one or more processors, and the one or more programs include an instruction, where the instruction is used for: identifying, when it is detected that a charging apparatus is inserted into a charging port of a terminal by using a charging cable, a first voltage value of the charging port; setting a second charging current; identifying a second voltage value of the charging port at the second charging current; calculating a cable impedance of the charging cable according to the first voltage value, the second charging current, and the second voltage value; and adjusting a suitable charging current of the charging apparatus according to the cable impedance of the charging cable.

With reference to the third aspect, in a first possible implementation manner of the third aspect, the calculating a cable impedance of the charging cable according to the first voltage value, the second charging current, and the second voltage value is specifically: R=(V₁−V₂)/I₂, where R is the cable impedance of the charging cable, V₁ is the first voltage value, V₂ is the second voltage value, and I₂ is the second charging current.

With reference to the first possible implementation manner of the third aspect, in a second possible implementation manner of the third aspect, the instruction is further used for prompting a user when the cable impedance of the charging cable is greater than a preset impedance value.

With reference to any one of the third aspect, the first possible implementation manner of the third aspect, or the second possible implementation manner of the third aspect, in a third possible implementation manner of the third aspect, the adjusting a suitable charging current of the charging apparatus according to the cable impedance of the charging cable includes: adjusting a third charging current to a fourth charging current; identifying a fourth voltage value of the charging port at the fourth charging current; calculating an output voltage value of the charging apparatus according to a rated voltage value of the charging apparatus, the fourth charging current and the cable impedance of the charging cable; and determining, if the fourth voltage value is less than the output voltage value of the charging apparatus, that the third charging current is the suitable charging current of the charging apparatus.

With reference to the third possible implementation manner of the third aspect, in a fourth possible implementation manner of the third aspect, the calculating an output voltage value of the charging apparatus according to a rated voltage value of the charging apparatus, the fourth charging current and the cable impedance of the charging cable is specifically: V=V_{adapter}−I₄×R, where V is the output voltage value of the charging apparatus, V_{adapter} is the rated voltage value of the charging apparatus, I₄ is the fourth charging current, and R is the cable impedance of the charging cable.

A fourth aspect of the present invention provides a terminal, where the terminal includes: one or more processors, a memory and one or more programs, where the one or more programs are stored in the memory, and are configured to be executed by the one or more processors, and the one or more programs include an instruction for performing the method according to any one of the first aspect to the fourth possible implementation manner of the first aspect.

A fifth aspect of the present invention provides a computer-readable storage medium for storing one or more programs, where the one or more programs include an instruction, and when executed by the terminal, the instruction enables the terminal to perform the method according to any one of the first aspect to the fourth possible implementation manner of the first aspect.

In the foregoing technical solutions, the present invention provides a charging method, a charging apparatus, a terminal, and a computer-readable storage medium. By identifying, when it is detected that a charging apparatus is inserted into a charging port of a terminal by using a charging cable, a first voltage value of the charging port; setting a second charging current; identifying a second voltage value of the charging port at the second charging current; calculating a cable impedance of the charging cable according to the first voltage value, the second charging current, and the second voltage value; and adjusting a suitable charging current of the charging apparatus according to the cable impedance of the charging cable, the terminal can adapt to different charging apparatuses, improving charging experience of a user.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of charging a terminal by a charging apparatus;

FIG. 2 is a schematic diagram of a charging method according to an embodiment of the present invention;

FIG. 3 is a schematic diagram of a method for adjusting a charging current according to an embodiment of the present invention;

FIG. 4 is a schematic diagram of a terminal according to an embodiment of the present invention;

FIG. 5 is a schematic structural diagram of a first adjustment unit according to an embodiment of the present invention; and

FIG. 6 is a schematic diagram of another terminal according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some rather than all of the embodiments of the present invention. All other embodiments obtained by a person of ordinary skill in the art based on the embodiments of the present invention without creative efforts shall fall within the protection scope of the present invention.

Ordinals such as “first” and “second” mentioned in the embodiments of the present invention, unless indeed indicating orders according to the context, should be considered to be used merely for distinguishing.

A terminal in the embodiments of the present invention may include a mobile phone, a tablet computer, an MP3 player, a wearable device such as a smart watch, and the like.

When a user charges the terminal by using a charging apparatus such as a non-original adapter, because a charging current that is set by the terminal such as a mobile phone is relatively large and exceeds a rated current of the adapter, overcurrent protection is generated by the charging apparatus, and charging cannot be performed. When the user uses a charging cable of relatively poor quality, for example, a USB cable, a voltage shunted to the cable is excessively large, and a voltage reaching a mobile phone end is relatively low due to an impedance problem of the USB cable. Consequently, there are problems that charging is slow, charging cannot even be performed, and the like. In addition, because the cable impedance of the charging cable of relatively poor quality is relatively large, there is relatively much heat generated from the charging cable, and this situation is relatively dangerous.

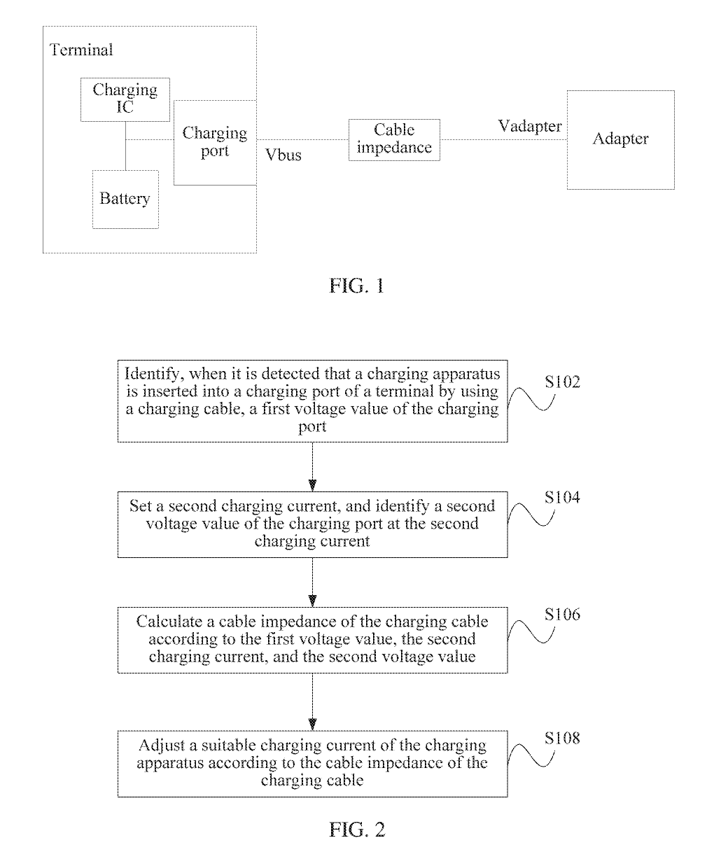

The following describes, by using an example in which the charging apparatus is an adapter and the terminal is a mobile phone, voltage changes of a charging port of the mobile phone when the mobile phone is charged by the adapter. FIG. 1 is a schematic diagram of charging the terminal by the adapter. When the adapter is inserted into the terminal to charge the terminal, the terminal may identify whether the adapter is an original adapter by detecting whether an output voltage of the adapter is excessively low. If the adapter is not an original adapter of the terminal, after the adapter is connected to the charging port of the terminal by using a charging cable, a charging IC (Integrated Chip, integrated chip, IC for short) of the mobile phone may set an initial charging current I₀, for example, I₀=500 ma. In this case, because the charging current is relatively small, and is less than a rated charging current of the adapter, it may be considered that the output voltage V of the adapter is equal to a voltage V_{bus} of the charging port. The terminal may obtain the voltage V_{bus} of the charging port by detecting the charging port by using the charging IC. Then, the charging IC of the mobile phone gradually improves the charging current with a unit of ΔI, that is, Iᵢ=I₀+ΔI×i. Iᵢ is an improved charging current, I₀ is the preset initial charging current, ΔI is an adjustment value of the charging current, i is a nonnegative integer, and i=0, 1, 2, . . . . For example, ΔI=100 ma. Because there is a cable impedance R on the charging cable, as the charging current Iᵢ is constantly improved, the output voltage V of the adapter decreases gradually. The charging IC detects the voltage value V_{bus} of the charging port at any time, and V_{bus} also decreases gradually as the charging current Iᵢ is improved. Before the output voltage of the adapter is pulled down by an overcurrent, it maybe considered that V is basically equal to V_{bus}. When V_{bus} gradually decreases and falls down to a value near a preset voltage value, the adapter stops charging the mobile phone because of existence of overcurrent protection.

A rated voltage of the adapter is marked as V_{adapter}, the output voltage V of the adapter gradually decreases as the charging current Iᵢ is improved, and there is the following relationship between the output voltage V of the adapter and the rated voltage V_{adapter} of the adapter: V=V_{adapter}−Iᵢ×R. It can be seen that V is the output voltage of the adapter obtained through calculation in consideration of existence of the cable impedance R. V_{bus} is the voltage of the charging port of the terminal detected by the charging IC. V and V_{bus} may be or may not be equal.

### EMBODIMENT 1

FIG. 2 shows a charging method according to this embodiment of the present invention. The method may be performed by a terminal such as a mobile phone, or a tablet computer. The method includes the following steps.

S102: Identify, when it is detected that a charging apparatus is inserted into a charging port of a terminal by using a charging cable, a first voltage value of the charging port.

The charging apparatus may be an apparatus such as an adapter or a mobile power pack that can charge the terminal. The adapter is also referred to as a charger, and may be roughly divided into a travel charger, a docking charger, and a maintenance charger. The charging port of the terminal may be an port that can connect the terminal and the charging apparatus, such as a USB port, a mini USB port, a USB 3.0 port, a thunderbolt port, or a USB-C port. Commonly used charging cables include a USB charging cable, a thunderbolt (thunderbolt) charging cable from Apple Inc., and the like. Specifically, the first voltage value of the charging port may be identified by means of detection of a charging IC of the terminal.

S104: Set a second charging current, and identify a second voltage value of the charging port at the second charging current.

If the charging apparatus is a non-original charging apparatus, the terminal may preset a second charging current when the charging apparatus is just inserted into the charging port of the terminal, to serve as an initial charging current. A charging current refers to an output current of the charging apparatus when the charging apparatus charges the terminal. The initial charging current is generally less than a rated current of the charging apparatus. The terminal may identify, by using the charging IC of the terminal, the second voltage value of the charging port at the second charging current.

S106: Calculate a cable impedance of the charging cable according to the first voltage value, the second charging current, and the second voltage value.

Different types of charging cables have different cable impedances. A cable impedance of a charging cable of good quality is approximately 300 mΩ, and a cable impedance of a charging cable of poorer quality is approximately 700 mΩ. A cable impedance of a charging cable can be obtained through calculation in step S106. If the cable impedance obtained through calculation exceeds a preset impedance value, a user may be reminded to replace the charging cable because if the cable impedance is relatively large, a case in which charging is slow or charging cannot even be performed occurs; and if charging is forced, insecure factors such as heat generation of the charging cable are caused.

S108: Adjust a suitable charging current of the charging apparatus according to the cable impedance of the charging cable.

A charging current of the charging apparatus obtained through adjustment in step S108 is within a range of a rated output current of the adapter, and is therefore the suitable charging current of the charging apparatus. When the charging current output by the adapter is within a range of a rated current of the adapter, an output voltage of the adapter is stable, so that the terminal can be better charged, improving charging experience of the user.

In this embodiment of the present invention, a cable impedance of a charging cable is calculated, and a charging current of a charging apparatus is adjusted to a suitable charging current, so that the terminal can adapt to different charging apparatuses, improving charging experience of a user.

Specifically, the calculating a cable impedance of the charging cable according to the first voltage value, the second charging current, and the second voltage value in step S106 may use the following formula:

R=(V₁−V₂)/I₂, where R is the cable impedance of the charging cable, V₁ is the first voltage value, V₂ is the second voltage value, and I₂ is the second charging current.

Optionally, when the cable impedance of the charging cable obtained through calculation is greater than a preset impedance value, a user is prompted. The preset impedance value may be set according to a requirement, for example, the preset impedance value may be 650 mΩ. When the cable impedance of the charging cable obtained through calculation is greater than 650 mΩ, the user is prompted, and the user may be reminded to replace the charging cable because if the cable impedance is relatively large, a case in which charging is slow or charging cannot even be performed occurs; and if charging is forced, insecure factors such as heat generation of the charging cable are caused. There are various manners in which the user is reminded. The user may be reminded, on a UI (User Port, user port, UI for short) of the terminal, that the charging cable is not suitable to charge the terminal; and replace the charging cable. Alternatively, the user may be reminded to replace the charging cable in a manner in which an indicator light of the terminal blinks.

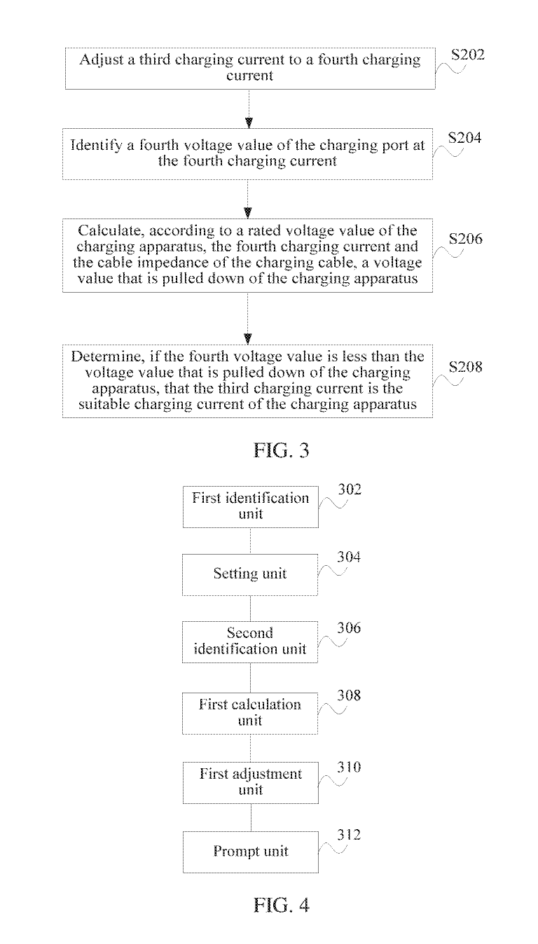

Specifically, the adjusting a suitable charging current of the charging apparatus according to the cable impedance of the charging cable in step S108 includes steps shown in FIG. 3.

S202: Adjust a third charging current to a fourth charging current.

The third charging current may be a preset charging current value, and may be set by the charging IC of the terminal. The third charging current may be adjusted to the fourth charging current in various manners. For example, the third charging current is adjusted to the fourth charging current by directly adding one ΔI, or by gradually increasing the current by means of step improvement. Refer to the foregoing descriptions about the charging current Iᵢ for a specific method for gradually improving a current.

S204: Identify a fourth voltage value of the charging port at the fourth charging current.

When the charging current is the fourth charging current, the charging IC of the terminal identifies the fourth voltage value of the charging port.

S206: Calculate an output voltage value of the charging apparatus according to a rated voltage value of the charging apparatus, the fourth charging current and the cable impedance of the charging cable.

The rated voltage value of the charging apparatus is V_{adapter}. Because there is the cable impedance, when the rated voltage of the charging apparatus reaches the charging port of the terminal through the charging cable, the output voltage value of the charging apparatus is not equal to the rated voltage of the charging apparatus, and the output voltage value of the charging apparatus may be calculated according to step S206.

S208: Determine, if the fourth voltage value is less than the output voltage value of the charging apparatus, that the third charging current is the suitable charging current of the charging apparatus.

The fourth voltage value is a voltage value of the charging port of the terminal that is detected by using the charging IC by the terminal. The output voltage value of the charging apparatus is a theoretical output voltage value of the charging apparatus that is obtained through calculation. If the fourth voltage value is less than the output voltage value of the charging apparatus, indicating that the output voltage of the charging apparatus is pulled down by an overcurrent, the fourth charging current may have exceeded a range of a rated current of the charging apparatus, and is not the suitable charging current of the charging apparatus, and the third charging current is the suitable charging current of the charging apparatus. The third charging current obtained in this manner is within the range of the rated current of the charging apparatus. The output voltage of the charging apparatus is stable when the output current of the charging apparatus is within the range of the rated current, so that the terminal can be better charged, improving charging experience.

The calculating an output voltage value of the charging apparatus according to a rated voltage value of the charging apparatus, the fourth charging current and the cable impedance of the charging cable in step S206 may specifically use the following formula:

V=V_{adapter}−I₄×R, where V is the output voltage value of the charging apparatus, V_{adapter} is the rated voltage value of the charging apparatus, I₄ is the fourth charging current, and R is the cable impedance of the charging cable.

According to the charging method provided in this embodiment of the present invention, by identifying, when it is detected that a charging apparatus is inserted into a charging port of a terminal by using a charging cable, a first voltage value of the charging port; setting a second charging current; identifying a second voltage value of the charging port at the second charging current; calculating a cable impedance of the charging cable according to the first voltage value, the second charging current, and the second voltage value; and adjusting a suitable charging current of the charging apparatus according to the cable impedance of the charging cable, the terminal can adapt to different charging apparatuses, and can be better charged, improving charging experience of a user.

### EMBODIMENT 2

FIG. 4 shows a charging apparatus according to this embodiment of the present invention. The charging apparatus includes:

a first identification unit 302, configured to identify, when it is detected that a charging apparatus is inserted into a charging port of a terminal by using a charging cable, a first voltage value of the charging port;

a setting unit 304, configured to set a second charging current;

a second identification unit 306, configured to identify a second voltage value of the charging port at the second charging current;

a first calculation unit 308, configured to calculate a cable impedance of the charging cable according to the first voltage value, the second charging current, and the second voltage value; and

a first adjustment unit 310, configured to adjust a suitable charging current of the charging apparatus according to the cable impedance of the charging cable.

Specifically, the first calculation unit 308 calculates the cable impedance of the charging cable by using the following formula: R=(V₁−V₂)/I₂, where R is the cable impedance of the charging cable, V₁ is the first voltage value, V₂ is the second voltage value, and I₂ is the second charging current.

Optionally, the charging apparatus further includes a prompt unit 312, configured to prompt a user when the cable impedance of the charging cable is greater than a preset impedance value.

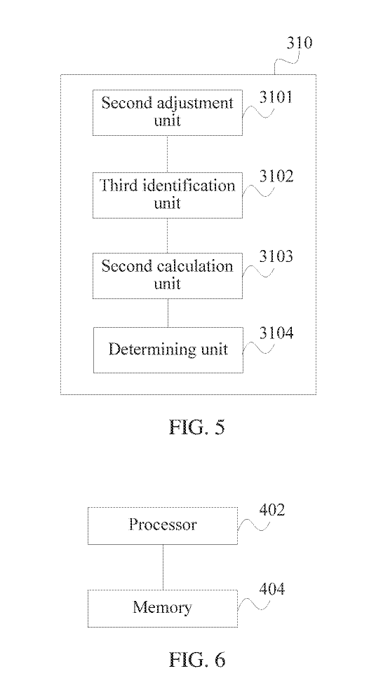

Specifically, as shown in FIG. 5, the first adjustment unit 310 includes:

a second adjustment unit 3101, configured to adjust a third charging current to a fourth charging current;

a third identification unit 3102, configured to identify a fourth voltage value of the charging port at the fourth charging current;

a second calculation unit 3103, configured to calculate an output voltage value of the charging apparatus according to a rated voltage value of the charging apparatus, the fourth charging current and the cable impedance of the charging cable; and

a determining unit 3104, configured to determine, if the fourth voltage value is less than the output voltage value of the charging apparatus, that the third charging current is the suitable charging current of the charging apparatus.

Specifically, the second calculation unit 3103 is specifically configured to: V=V_{adapter}−I₄×R, where V is the output voltage value of the charging apparatus, V_{adapter} is the rated voltage value of the charging apparatus, I₄ is the fourth charging current, and R is the cable impedance of the charging cable.

### EMBODIMENT 3

FIG. 6 shows a terminal according to this embodiment of the present invention. The terminal includes: one or more processors 402; a memory 404; and one or more programs. The one or more programs are stored in the memory, and are configured to be executed by the one or more processors. The one or more programs include an instruction, where the instruction is used for:

identifying, when it is detected that a charging apparatus is inserted into a charging port of a terminal by using a charging cable, a first voltage value of the charging port;

setting a second charging current;

identifying a second voltage value of the charging port at the second charging current;

calculating a cable impedance of the charging cable according to the first voltage value, the second charging current, and the second voltage value; and

adjusting a suitable charging current of the charging apparatus according to the cable impedance of the charging cable.

Specifically, the calculating a cable impedance of the charging cable according to the first voltage value, the second charging current, and the second voltage value is specifically:

R=(V₁−V₂)/I₂, where R is the cable impedance of the charging cable, V₁ is the first voltage value, V₂ is the second voltage value, and I₂ is the second charging current.

Optionally, when the cable impedance of the charging cable is greater than a preset impedance value, a user is prompted.

Specifically, the adjusting a suitable charging current of the charging apparatus according to the cable impedance of the charging cable includes:

adjusting a third charging current to a fourth charging current;

identifying a fourth voltage value of the charging port at the fourth charging current;

calculating an output voltage value of the charging apparatus according to a rated voltage value of the charging apparatus, the fourth charging current and the cable impedance of the charging cable; and

determining, if the fourth voltage value is less than the output voltage value of the charging apparatus, that the third charging current is the suitable charging current of the charging apparatus.

Specifically, the calculating an output voltage value of the charging apparatus according to a rated voltage value of the charging apparatus, the fourth charging current and the cable impedance of the charging cable is specifically: V=V_{adapter}−I₄×R, where V is the output voltage value of the charging apparatus, V_{adapter} is the rated voltage value of the charging apparatus, I₄ is the fourth charging current, and R is the cable impedance of the charging cable.

### EMBODIMENT 4

This embodiment of the present invention further provides a computer-readable storage medium. One or more programs are stored in the computer-readable storage medium, and the one or more programs include an instruction. When executed by the terminal, the instruction enables the terminal to perform any method according to Embodiment 1.

Finally, it should be noted that the foregoing embodiments are merely examples for describing the technical solutions of the present invention other than limiting the present invention. Although the present invention and benefits of the present invention are described in detail with reference to the foregoing embodiments, a person of ordinary skill in the art should understand that they may still make modifications to the technical solutions described in the foregoing embodiments or make equivalent replacements to some technical features thereof, without departing from the scope of the claims of the present invention.

1-17. (canceled)

18. A charging method, comprising:
identifying, when it is detected that a charging apparatus is inserted into a charging port of a terminal by using a charging cable, an initial voltage value of the charging port;
setting a first charging current of the charging apparatus;
identifying a first voltage value of the charging port at the first charging current;
calculating a cable impedance of the charging cable according to the initial voltage value, the first charging current, and the first voltage value; and
adjusting a the first charging current of the charging apparatus to a second charging current according to the cable impedance of the charging cable.

19. The method according to claim 18, wherein calculating a cable impedance of the charging cable according to the initial voltage value, the first charging current, and the first voltage value comprises:
R=(V₁−V₂)/I₂, wherein R is the cable impedance of the charging cable, V₁ is the initial voltage value, V₂ is the first voltage value, and I₂ is the first charging current.

20. The method according to claim 19, further comprising:
prompting a user when the cable impedance of the charging cable is greater than a preset impedance value.

21. The method according to claim 18, wherein adjusting the first charging current of the charging apparatus to a second charging current according to the cable impedance of the charging cable comprises:
adjusting the second charging current to a fourth charging current;
identifying a fourth voltage value of the charging port at the fourth charging current;
calculating an output voltage value of the charging apparatus according to a rated voltage value of the charging apparatus, the fourth charging current and the cable impedance of the charging cable; and
determining, when the fourth voltage value is less than the output voltage value of the charging apparatus, that the second charging current is the suitable charging current of the charging apparatus, and adjusting the fourth charging current back to the second charging current.

22. The method according to claim 21, wherein calculating an output voltage value of the charging apparatus according to a rated voltage value of the charging apparatus, the third charging current and the cable impedance of the charging cable comprises:
V=V_{adapter}−I₄×R, wherein V is the output voltage value of the charging apparatus, V_{adapter} is the rated voltage value of the charging apparatus, I₄ is the third charging current, and R is the cable impedance of the charging cable.

23. A terminal, comprising:
one or more processors;
a memory for storing one or more programs which, when executed by the one or more processors, cause the terminal to:
identify, when it is detected that a charging apparatus is inserted into a charging port of the terminal by using a charging cable, an initial voltage value of the charging port;
set a first charging current;
identify a first voltage value of the charging port at the first charging current;
calculate a cable impedance of the charging cable according to the initial voltage value, the first charging current, and the first voltage value; and
adjust the first charging current of the charging apparatus to a second charging current according to the cable impedance of the charging cable.

24. The terminal according to claim 23, wherein the cable impedance is calculated according to:
R=(V₁−V₂)/I₂, wherein R is the cable impedance of the charging cable, V₁ is the initial voltage value, V₂ is the first voltage value, and I₂ is the first charging current.

25. The terminal according to claim 24, wherein the one or more programs, when executed by the one or more processors, further cause the terminal to:
prompt a user when the cable impedance of the charging cable is greater than a preset impedance value.

26. The terminal according to claim 23, wherein to adjust the first charging current of the charging apparatus to the second charging current according to the cable impedance of the charging cable, the one or more programs, when executed by the one or more processors, cause the terminal to:
adjust the second charging current to a fourth charging current;
identify a fourth voltage value of the charging port at the fourth charging current;
calculate an output voltage value of the charging apparatus according to a rated voltage value of the charging apparatus, the fourth charging current and the cable impedance of the charging cable; and
determine, when the fourth voltage value is less than the output voltage value of the charging apparatus, that the second charging current is a suitable charging current of the charging apparatus, and adjust the fourth charging current back to the second charging current.

27. The terminal according to claim 26, wherein the output voltage value is calculated according to:
V=V_{adapter}−I₄×R, wherein V is the output voltage value of the charging apparatus, V_{adapter} is the rated voltage value of the charging apparatus, I₄ is the fourth charging current, and R is the cable impedance of the charging cable.
